(19) United States
(12) Patent Application Publication
(10) Pub. No.: US 2024/0090384 A1
(43) Pub. Date: Mar. 21, 2024

(54) GARDEN TOOL AND PARALLEL POSITION SENSING SYSTEM

(71) Applicant: Milwaukee Electric Tool Corporation, Brookfield, WI (US)

(72) Inventors: Justin M. Czok, Park Ridge, IL (US); Brandon S. Michaud, Chicago, IL (US); Sara M. Manulik, Chicago, IL (US); Sean E. Conaway, Milwaukee, WI (US)

(21) Appl. No.: 18/469,902

(22) Filed: Sep. 19, 2023

Related U.S. Application Data
(60) Provisional application No. 63/408,432, filed on Sep. 20, 2022.

(51) Int. Cl. A01G 3/053; G01D 5/14

(52) U.S. Cl. CPC A01G 3/0535; G01D 5/145

(57) ABSTRACT

A blade position sensing system for a garden tool is provided. The system includes a driveshaft coupled to one or more blades of a blade assembly. The driveshaft is operably coupled to a motor to selectively rotate the driveshaft relative to a threaded shaft and translate the driveshaft along a linear direction. The driveshaft and the threaded shaft are coupled to one another at a threaded interface. Linear translation of the driveshaft angularly translates one or more blades of the blade assembly. A magnet is coupled to the driveshaft. A proximity sensor is positioned in magnetic communication with the driveshaft. A change in distance between the proximity sensor and the driveshaft changes an output voltage by the proximity sensor.

### PRIORITY STATEMENT

The present application claims the benefit of priority to U.S. patent application No. 63/408,432 titled “PARALLEL POSITION SENSING SYSTEM”, filed on Sep. 20, 2022, the disclosure of which is incorporated by reference herein in its entirety.

### FIELD

The present disclosure relates generally to garden tools having opposing blade, and more particularly to an improved parallel position sensing designs for garden tool blades.

### BACKGROUND

Existing garden tools typically employ at least two opposing blades pivotably connected. Application of an external force causes one or more of the blades to move in the direction of the opposing blade. The one or more blades move from an open position, in which the ends of the blades are separated from one another to a closed position, in which at least a portion of the blades slide by one another in close proximity. Through this motion, objects between the blades when in the open position may be cut when the blades transition to the closed position.

The distance of travel of the one or more moving blades can affect the amount of force or energy necessary to perform the cutting operation and may further impact the effectiveness of said cutting operation. Some circumstances, such as general wear and tear on the product over time, may alter the distance of travel of the one or more moving blades, resulting in overtravel of the blade in either the opening or closing direction, thereby limiting reducing the utility of the tool.

Accordingly, improved parallel position sensing designs for controlling the distance of travel of one or more moving blades of the tool is desirable.

### BRIEF DESCRIPTION

Aspects and advantages of the invention will be set forth in part in the following description, or may be understood from the description, or may be learned through practice of the invention.

An aspect of the present disclosure is directed to a blade position sensing system for a garden tool. The system includes a driveshaft coupled to one or more blades of a blade assembly. The driveshaft is operably coupled to a motor to selectively rotate the driveshaft relative to a threaded shaft and translate the driveshaft along a linear direction. The driveshaft and the threaded shaft are coupled to one another at a threaded interface. Linear translation of the driveshaft angularly translates one or more blades of the blade assembly. A magnet is coupled to the driveshaft. A proximity sensor is positioned in magnetic communication with the driveshaft. A change in distance between the proximity sensor and the driveshaft changes an output voltage by the proximity sensor.

Another aspect of the present disclosure is directed to a garden tool. The garden tool includes a shaft extending along a linear direction. A power supply is configured to selectively transmit energy to a motor. A blade assembly is positioned at the shaft. A blade position sensing system is positioned at the shaft. The system includes a driveshaft coupled to one or more blades of the blade assembly. The driveshaft is operably coupled to the motor to selectively rotate relative to a threaded shaft and translate along the linear direction. The driveshaft and the threaded shaft are coupled to one another at a threaded interface. Linear translation of the driveshaft angularly translates one or more blades of the blade assembly. A magnet is coupled to the driveshaft. A proximity sensor is positioned in magnetic communication with the driveshaft. A change in distance between the proximity sensor and the driveshaft changes an output voltage by the proximity sensor. A controller is configured to receive a signal corresponding to the output voltage from the proximity signal. The controller is configured to selectively discontinue transmission of energy from the power supply to the motor based on the signal corresponding to the output voltage.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF FIGURES

A full and enabling disclosure of the present invention, including the best mode thereof, directed to one of ordinary skill in the art, is set forth in the specification, which makes reference to the appended figures, in which:

FIG. 1 is a perspective view of an exemplary embodiment of a garden tool including an embodiment of a blade position sensing system in accordance with aspects of the present disclosure;

FIG. 2 is a detailed perspective view of an embodiment of the garden tool including an embodiment of the blade position sensing system in accordance with aspects of the present disclosure;

FIG. 3 is a schematic cross sectional view of an embodiment of the blade position sensing system in accordance with aspects of the present disclosure;

FIG. 4 is a perspective view of an embodiment of a driveshaft of the blade position sensing system in accordance with aspects of the present disclosure;

FIG. 5 is a side view depicting a partial internal view of the blade position sensing system in accordance with aspects of the present disclosure; and

FIG. 6 is a side view depicting a partial internal view of the blade position sensing system in accordance with aspects of the present disclosure.

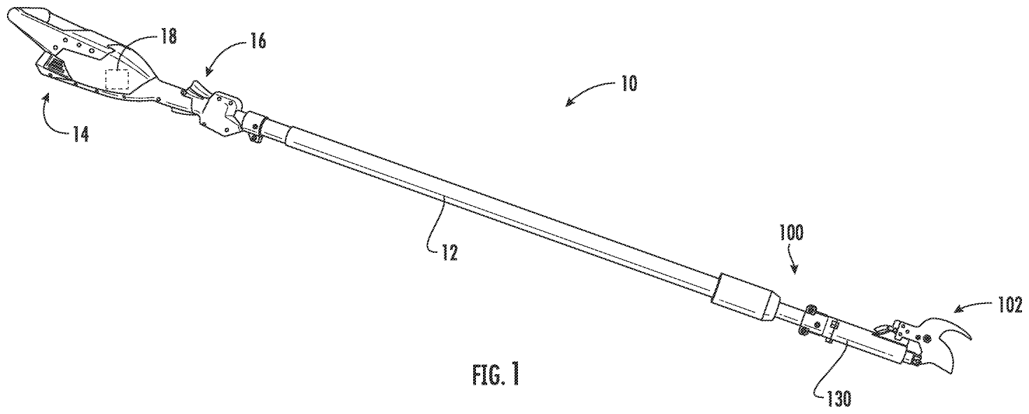

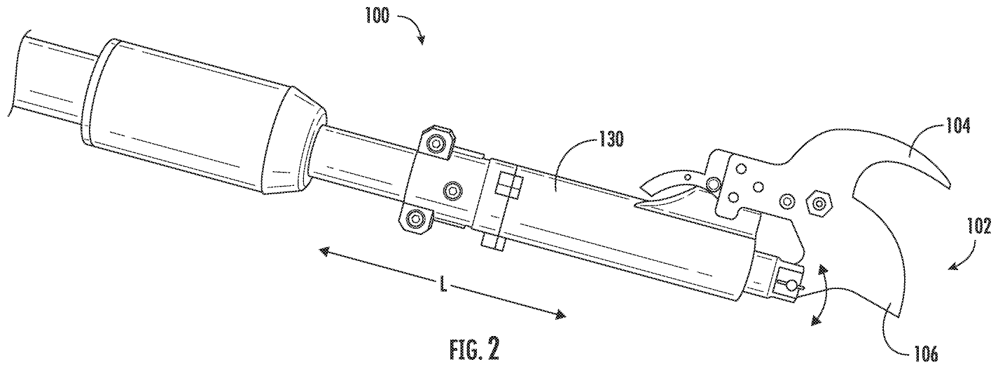

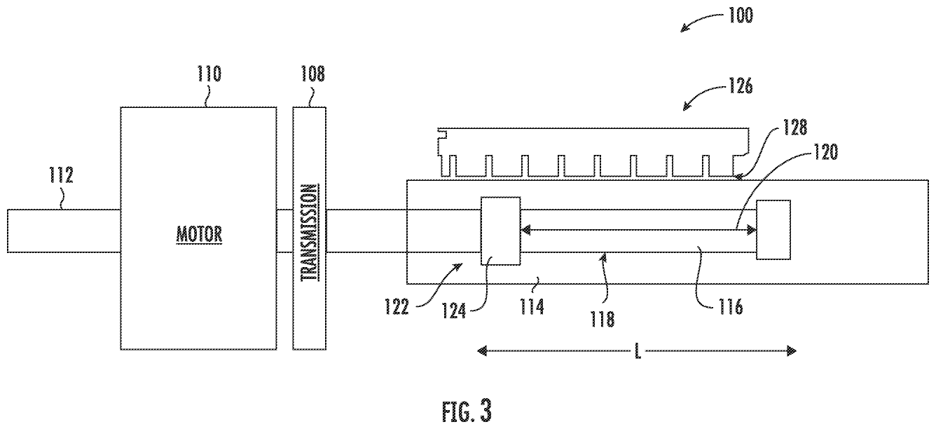

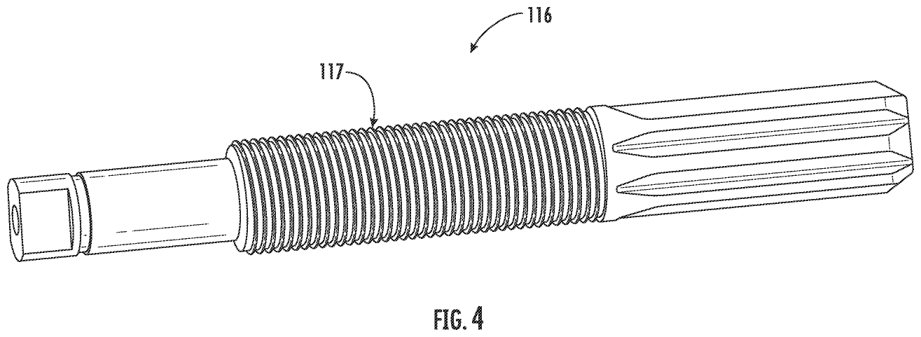

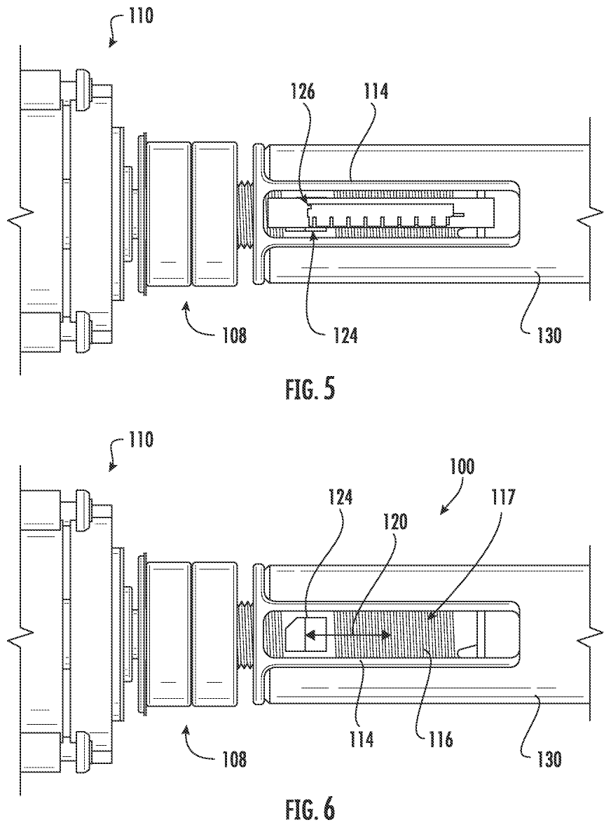

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Embodiments of a blade position sensing system 100 are provided. Aspects of the disclosure are further directed to a garden tool 10 including embodiments of the system 100. Embodiments of blades being controlled by the system 100 include blades at the garden tool 10, such as the garden tool 10 forming one or more embodiments of a cutting tool, shears loppers, pruners, or garden tools for cutting branches and the like. Embodiments of the present disclosure include control of a blade position using a parallel position sensing system.

Embodiments of the garden tool 10 may include a shaft 12. A power supply 14, such as an electrical power supply (e.g., battery, corded electrical input, etc.) or engine, is positioned at a first end of the shaft 12. The shaft 12 may include handles, grips, or other surfaces configured to facilitate user holding and handling of the garden tool 10. A trigger 16 is configured to allow the user to articulate to selectively operate the power supply 14 to discharge power to and operate a motor, such as further described herein. A controller 18 is operably coupled to the power supply 14 and the trigger 16, such as to control or limit a release of energy from the power supply 14, such as further described herein. A second end of the shaft 12 distal to the power supply 14 includes a blade assembly 102 controllable by the system 100, such as further described herein.

It should be appreciated that the controller 18 may include any suitable configuration of processor(s), memory device(s), wired or wireless communications device(s), and buses as may generally be known for receiving and transmitting signals among one or more components described herein, such as to selectively operate the system 100 as described herein.

In various embodiments, blade assembly 102 being controlled by the system 100 include a first blade 104, such as forming a fixed blade, and a second blade 106, such as forming a movable blade. Blades 202 may be pivotably connected relative to one another. In some embodiments, the movable blade 106 is driven via a transmission system 108. A motor 110, such as an electric motor, is operably coupled to the transmission system 108 to provide energy and power to articulate the blade 106. In still some embodiments, the motor 110 is operably connected to a motor shaft 112 that rotates when driven by the motor 110. The motor shaft 112 may be operably connected to a gearbox. The transmission system 108 may include a gear assembly, such as one or more planetary gear sets that drive the transmission system.

In still some embodiments, the movable blade 106 may be driven by manual power. For instance, a user may manually articulate a shaft or handle to move the second blade 106 relative to the first blade 104.

In various embodiments, a driveshaft 114 is coupled to the moveable blade 106. In some embodiments, the driveshaft 114 is directly connected to the moveable blade 106. In still some embodiments, the driveshaft 114 is indirectly connected to the moveable blade 106. For instance, indirect coupling of the moveable blade 106 to the driveshaft 114 may include a component configured to translate rotary motion into linear motion, such as, but not limited to, a ball screw. An opposite end of the driveshaft 114 from the blade 106 may be coupled to the transmission system 108.

In an embodiment of operation of the system 100, rotation of the driveshaft 114 in a first direction drives the movable blade 106 from an first position to a second position, such as from an open position to a closed position. Rotation of the driveshaft 114 in a second direction drives the movable blade 106 in an opposite direction, such as from the second position to the first position. For example, rotation of the driveshaft 114 in the second direction drives the moveable blade 105 from the closed position to the open position. In another example, rotation of the driveshaft 114 in a clockwise direction drives the moveable blade 106 from the open position to the closed position, and rotation of the driveshaft 114 in a counterclockwise direction drives the moveable blade 106 from the closed position to the open position. However, it should be appreciated that the system 100 may be configured for rotation in the clockwise direction drives from closed to open, and rotation in the counterclockwise direction drives from open to closed.

In various embodiments, the driveshaft 114 rotates about a threaded shaft 116. The threaded shaft 116 may form a threaded lead screw. The driveshaft 114 and threaded shaft 116 may together form a threaded interface 118. The threaded interface 118 may include the driveshaft 114 forming complementary internal threads corresponding to external threads 117 of the threaded shaft 116. An exemplary embodiment may include an M12×1 mm threading. However, it should be appreciated that other threading dimensions may be utilized.

In an embodiment of operation of the system 100, rotation of the driveshaft 114 such as described herein causes the driveshaft 114 to translate in a linear direction L parallel to an axis of extension 120 of the shaft 116. Linear translation of the driveshaft 114 articulates the moveable blade 106, such as to pivot relative to the first blade 104.

Embodiments of the system 100 may include a limit system 122 positioned in-line with the driveshaft 114 along the linear direction L. Embodiments of the limit system 122 include a magnet 124 configured to translate in the linear direction L as the driveshaft 114 translates along the linear direction L such as described herein. The magnet 124 may be positioned on or in the driveshaft 114 such that translation of the driveshaft 114 translates the magnet 124 in the linear direction L parallel to the axis 120 of the threaded shaft 116 as the driveshaft 114 translates in the same direction.

In various embodiments, a proximity sensor 126 is positioned in magnetic communication with the driveshaft 114. In still various embodiments, the proximity sensor 126 is mechanically de-coupled from direct connection to the driveshaft 114. For instance, the proximity sensor 126 is positioned in magnetic proximity to the driveshaft 114. A gap 128, such as a radial gap, is formed between the proximity sensor 126 and the driveshaft 114, such that the proximity sensor 126 is independent or de-coupled from direct connection to the driveshaft 114. As such, translation of the driveshaft 114, such as described herein, does not cause translation of the proximity sensor 126.

In some embodiments, the proximity sensor 126 is connected to an outer sleeve 130 surrounding the driveshaft 114.

In an embodiment of operation of the system 100, such as described herein, rotation and translation of the driveshaft 114 changes a distance between the proximity sensor 126 and the magnet 124. The change in distance between the proximity sensor 126 and the magnet 124 changes an output voltage by the proximity sensor 126. The output voltage corresponds to a linear distance of translation of the driveshaft 114. The output voltage corresponding to the linear distance of translation of the driveshaft 114 furthermore corresponds to a radial or angular distance of translation of the moveable blade 106 coupled to the driveshaft 114, such as described herein. As such, output voltage by the proximity sensor 126 corresponds to one or more positions of blades 102.

In various embodiments, the proximity sensor 126 is configured to determine a presence and magnitude of magnetic field. Output voltage of the proximity sensor 126 may be directly proportional to a magnitude of the magnetic field, such as described herein. For instance, the proximity sensor 126 may form a Hall effect sensor or Hall sensor.

Embodiments of the garden tool 10 including embodiments of the blade position sensing system 100 described herein may prevent overtravel of blades 102. In some embodiments, a desired distance of radial travel of the blade 106 is predetermined. The radial distance is correlated to output voltage of the proximity sensor 126. In various embodiments, the proximity sensor 126 is communicatively coupled to a controller (e.g., controller 18), such as via wired or wireless communication. The proximity sensor 126 is configured to transmit a signal corresponding to output voltage to the controller. The controller may be configured to discontinue power transmission from the motor 110 when the output voltage corresponds to an overtravel condition of the blades 102. For example, the controller may cut power to the motor 110 or decouple the transmission system 108 from the driveshaft 114 to discontinue power transmission to the driveshaft 114. The controller may include an upper or lower limit corresponding to radial or angular limits of translation of one or more blades 102, or linear limits of translation of the driveshaft 114, such as may avoid undesired overtravel. For instance, the upper or lower limits may correspond to upper or lower output voltage thresholds from the proximity sensor 116, such as described herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A garden tool, comprising:
a shaft extending along a linear direction;
a power supply configured to selectively transmit energy to a motor;
a blade assembly positioned at the shaft;
a blade position sensing system positioned at the shaft, the system comprising:
a driveshaft coupled to one or more blades of the blade assembly, the driveshaft operably coupled to the motor to selectively rotate relative to a threaded shaft and translate along the linear direction, the driveshaft and the threaded shaft coupled to one another at a threaded interface, and wherein linear translation of the driveshaft angularly translates one or more blades of the blade assembly;
a magnet coupled to the driveshaft;
a proximity sensor positioned in magnetic communication with the driveshaft, wherein a change in distance between the proximity sensor and the driveshaft changes an output voltage by the proximity sensor;
a controller configured to receive a signal corresponding to the output voltage from the proximity signal, the controller configured to selectively discontinue transmission of energy from the power supply to the motor based on the signal corresponding to the output voltage.

2. The garden tool of claim 1, wherein the blade assembly comprises a fixed blade and a movable blade, and wherein the moveable blade is coupled to the driveshaft.

3. The garden tool of claim 1, wherein the proximity sensor is a Hall effect sensor.

4. The garden tool of claim 1, wherein the proximity sensor is de-coupled from direct connection to the driveshaft.

5. The garden tool of claim 1, wherein the threaded interface of the driveshaft and the threaded shaft comprises external threads at the threaded shaft and internal threads at the driveshaft.

6. The garden tool of claim 1, comprising:
an outer sleeve at least partially surrounding the drive shaft.

7. The garden tool of claim 6, wherein the proximity sensor is coupled to the outer sleeve to position the proximity sensor in magnetic communication with the driveshaft.

8. The garden tool of claim 1, comprising:
a transmission system operably coupled to the driveshaft, the transmission system configured to receive energy from the motor and transmit energy to translate the driveshaft.

9. The garden tool of claim 1, wherein the magnet is positioned on or in the driveshaft such that translation of the driveshaft along the linear direction translates the magnet relative to the proximity sensor.

10. The garden tool of claim 1, wherein the proximity sensor forms a radial gap between the proximity sensor and the magnet.

11. A blade position sensing system for a garden tool, the system comprising:
a driveshaft coupled to one or more blades of a blade assembly, the driveshaft operably coupled to a motor to selectively rotate the driveshaft relative to a threaded shaft and translate the driveshaft along a linear direction, the driveshaft and the threaded shaft coupled to one another at a threaded interface, and wherein linear translation of the driveshaft angularly translates one or more blades of the blade assembly;
a magnet coupled to the driveshaft; and
a proximity sensor positioned in magnetic communication with the driveshaft, wherein a change in distance between the proximity sensor and the driveshaft changes an output voltage by the proximity sensor.

12. The system of claim 11, wherein the blade assembly comprises a fixed blade and a movable blade, and wherein the moveable blade is coupled to the driveshaft.

13. The system of claim 11, wherein the proximity sensor is a Hall effect sensor.

14. The system of claim 11, wherein the proximity sensor is de-coupled from direct connection to the driveshaft.

15. The system of claim 11, wherein the threaded interface of the driveshaft and the threaded shaft comprises external threads at the threaded shaft and internal threads at the driveshaft.

16. The system of claim 11, comprising:
an outer sleeve at least partially surrounding the drive shaft.

17. The system of claim 16, wherein the proximity sensor is coupled to the outer sleeve to position the proximity sensor in magnetic communication with the driveshaft.

18. The system of claim 11, comprising:
a transmission system operably coupled to the driveshaft, the transmission system configured to receive energy from the motor and transmit energy to translate the driveshaft.

19. The system of claim 11, wherein the magnet is positioned on or in the driveshaft such that translation of the driveshaft along the linear direction translates the magnet relative to the proximity sensor.

20. The system of claim 11, wherein the proximity sensor forms a radial gap between the proximity sensor and the magnet.
